(19) United States
(12) Patent Application Publication
(10) Pub. No.: US 2010/0064174 A1
(43) Pub. Date: Mar. 11, 2010

(54) Data processing system and debug method

(75) Inventor: Shinji Oosaki, Kanagawa (JP)

Correspondence Address: MCGINN INTELLECTUAL PROPERTY LAW GROUP, PLLC, 8321 OLD COURTHOUSE ROAD, SUITE 200, VIENNA, VA, 22182-3817, US

(73) Assignee: NEC ELECTRONICS CORPORATION, Kawasaki (JP)

(21) Appl. No.: 12/318,299

(22) Filed: Dec. 24, 2008

(30) Foreign Application Priority Data
Sep. 11, 2008 (JP) 2008-233247

(51) Int. Cl. G06F 11/26

(52) U.S. Cl. 714/34; 714/E11.159

(57) ABSTRACT

An exemplary aspect of the present invention is a data processing system, including a function block that operates based on a clock, a clock supply control circuit that controls supply of the clock based on an enable signal, a storing part that stores a command table in which a debug command and a number of clocks needed to process the debug command by the function block are made correspondent to each other, and a debug system part that executes debug processing based on an input debug command, in which the debug system part refers to the command table and outputs the enable signal in accordance with the number of clocks corresponding to the input debug command.

### BACKGROUND

1. Field of the Invention

The present invention relates to a data processing system and a debug method using the same, and more specifically, to a data processing system including a background debug processing function and a debug method using the same.

2. Description of Related Art

In recent years, further low power consumption has been demanded in battery-driven portable devices such as a portable telephone. In such portable devices, the mode is set to the low power consumption mode for most of the time even when a switch of a main body is in ON state. In this case, a clock is stopped, and a program in a micon is also stopped. On the other hand, in order to debug the program in such a stop state, the clock needs to be supplied to functional blocks such as a CPU, a memory, a register, and a peripheral device that are debug targets.

FIG. 4 illustrates FIG. 2 of Japanese Patent Translation Publication No. 2005-508531 (U.S. Pat. No. 6,823,224). A data processing system includes a clock unit 19, a CPU 12, and external oscillator components 30. The external oscillator components 30 include a crystal or resonator 32, a feedback resistor 34, and two load capacitors 36 and 38. The clock unit 19 includes an inverter 42, NAND gates 66 and 62, and a clock control 46.

Each of two input terminals to the NAND gate 66 is connected to a STOP signal 68 and the inverter 42, and an output terminal is connected to one input terminal of the NAND gate 62. The other input terminal of the NAND gate 62 is connected to the oscillator components 30 and the clock control 46, and the output terminal is connected to the oscillator components 30. An enable signal EN_BDM 44 is input to the inverter 42 from a background debug system 14. The clock control 46 supplies a background debug clock 54 to the BDS 14.

The CPU 12 includes the background debug system 14 connected to an address generation unit 74 through a command address bus 70. The address generation unit 74 receives a CPU address through a CPU address bus 72 and transmits a system address through an address bus 22. Further, the background debug system 14 is bidirectionally coupled to a background communication interface 52, a data bus 24, and a control signal 26.

Assume now that the STOP signal 68 for stopping the clock is High. When the background debug system 14 does not operate, which means that the background debug mode is in OFF state, the enable signal EN_BDM 44 is Low, and the output signal 40 of the inverter 42 is High. Accordingly, the output signal of the NAND gate 66 or one input signal 64 to the NAND gate 62 is Low. In this case, the logic of the other input signal of the NAND gate 62 and that of the output signal of the NAND gate 62 accord with each other. As such, the oscillator components 30 do not oscillate, and the clock stops.

On the other hand, when the background debug mode is in ON state, the enable signal EN_BDM 44 is High and the output signal 40 of the inverter 42 is Low. Accordingly, the output signal of the NAND gate 66 or one input signal 64 to the NAND gate 62 is High. In this case, the logic of the other input signal of the NAND gate 62 and that of the output signal of the NAND gate 62 are inverted from each other. Accordingly, the oscillator components 30 oscillate, and the clock operates. In short, when the background debug mode is in ON state, the clock can be operated.

### SUMMARY

However, according to the structure disclosed in Japanese Unexamined Patent Application Publication No. 2005-508531, the clock is operated at all times when the background debug mode is in ON state. Accordingly, the clock is supplied as is the same way as the normal operation even with the debug in low power consumption mode, and it is impossible to reproduce the low power consumption mode.

A first exemplary aspect of an embodiment of the present invention is a data processing system, including a function block that operates based on a clock, a clock supply control circuit that controls supply of the clock based on an enable signal, a storing part that stores a command table in which a debug command and a number of clocks needed to process the debug command by the function block are made correspondent to each other, and a debug system part that executes debug processing based on an input debug command, in which the debug system part refers to the command table and outputs the enable signal in accordance with the number of clocks corresponding to the input debug command.

A second exemplary aspect of an embodiment of the present invention is a debug method of a device including a function block that operates based on a clock, the method including stopping a clock signal, referring to a command table in which a debug command and a number of clocks needed to process the debug command by the function block are made correspondent to each other to supply the clock signal in accordance with the number of clocks corresponding to an input debug command, and executing debug processing based on the input debug command.

According to the present invention, it is possible to carry out the background debug processing while reproducing the low power consumption mode.

### BRIEF DESCRIPTION OF THE DRAWINGS

The above and other exemplary aspects, advantages and features will be more apparent from the following description of certain exemplary embodiments taken in conjunction with the accompanying drawings, in which:

FIG. 1 is a block diagram of a data processing system according to an exemplary embodiment of the present invention;

FIG. 2 is a flowchart of a data processing method according to the exemplary embodiment of the present invention;

FIG. 3 is a flowchart showing a method of determining a number of clocks according to the exemplary embodiment of the present invention; and

FIG. 4 illustrates FIG. 2 of Japanese Unexamined Patent Application Publication No. 2005-508531.

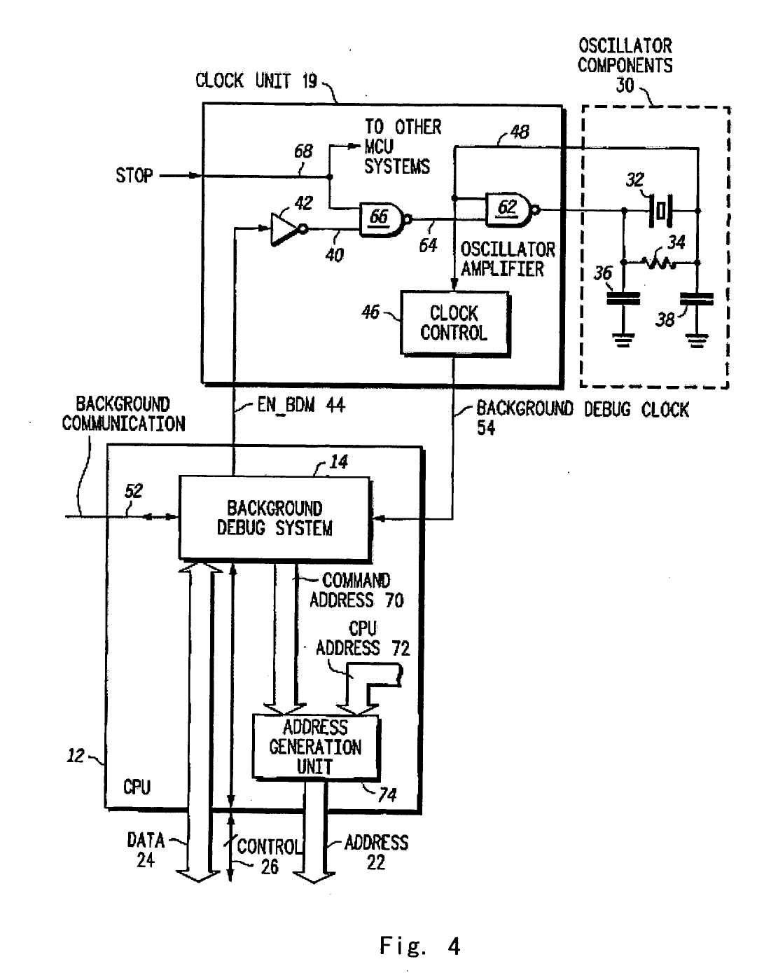

### DETAILED DESCRIPTION OF THE EXEMPLARY EMBODIMENTS

### First Exemplary Embodiment

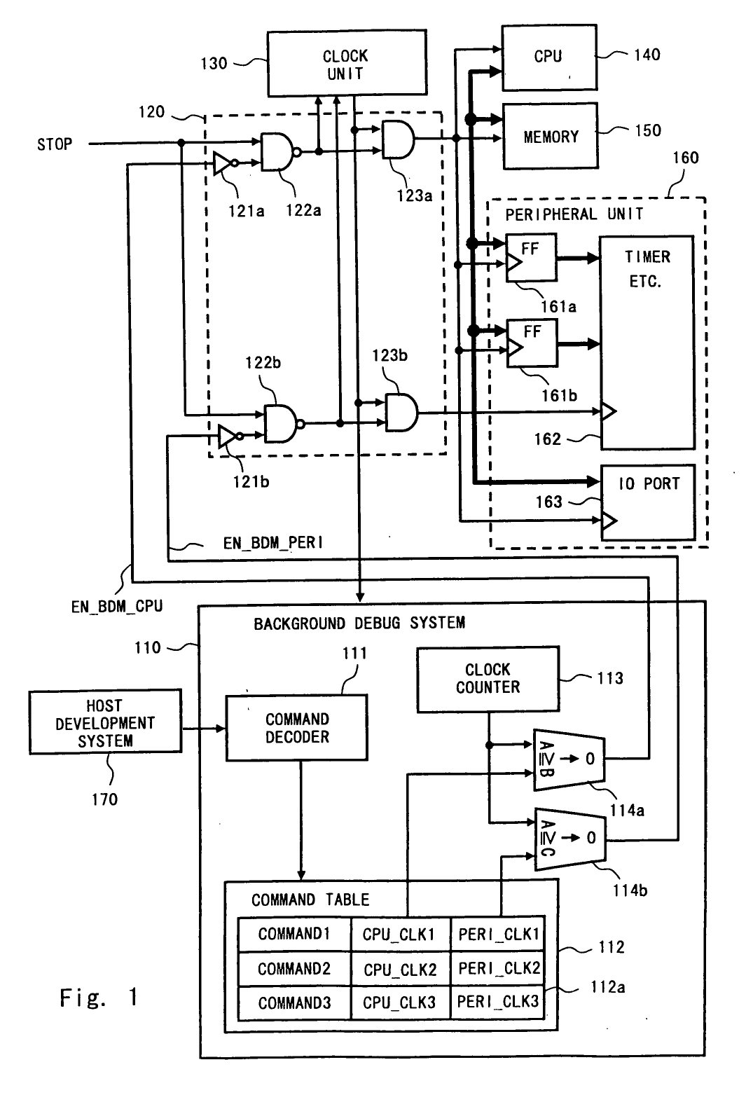

The exemplary embodiment of the present invention will be described with reference to the drawings. FIG. 1 is a block diagram of a data processing system according to the first exemplary embodiment. As shown in FIG. 1, the data processing system according to the first exemplary embodiment includes a background debug system 110, a clock supply control circuit 120, a clock unit 130, a CPU (Central Processing Unit) 140, a memory 150, and a peripheral unit 160.

The background debug system 110 includes a command decoder 111, a storing part 112, comparators 114a and 114b, and a clock counter 113. Further, the clock supply control circuit 120 includes inverters 121a and 121b, NAND gates 122a and 122b, and AND gates 123a and 123b. Further, the peripheral unit 160 includes flip flops 161a and 161b, a peripheral device 162 such as timer, and an IO port 163.

The command decoder 111 is connected to an external host development system 170 and the storing part 112. The command decoder 111 decodes a command input from the host development system 170 and outputs the decoded command information to the storing part 112.

The storing part 112 is connected to the command decoder 111 and the comparators 114a and 114b. The storing part 112 stores a command table 112a. A function block which is the target of the background debug processing and the number of clocks supplied to the function block is written in the command table 112a for each command. The number of clocks is predetermined for each function block in accordance with the background debug processing of each command.

In the example shown in FIG. 1, the numbers of clocks supplied to each of the CPU 140 and the peripheral device 162 such as the timer is predetermined. More specifically, when the background debug processing is carried out in COMMAND1, the number of clocks supplied to the CPU 140 is CPU_CLK1, and the number of clocks supplied to the peripheral device 162 such as the timer is PERI_CLK1. Further, when the processing is carried out in COMMAND2 and COMMAND3, the number of clocks supplied to the CPU 140 is CPU_CLK2 and CPU_CLK3, respectively, and the number of clocks supplied to the peripheral device 162 such as the timer is PERI_CLK2 and PERI_CLK3, respectively.

The storing part 112 outputs the number of clocks CPU_CLK supplied to the CPU 140 for the selected command to the comparator 114a as a value B. Further, the storing part 112 outputs the number of clocks PERI_CLK supplied to the peripheral device 162 such as the timer for the selected command to the comparator 114b as a value C.

The clock counter 113 is connected to the comparators 114a and 114b. Further, the clock counter 113 counts the clocks based on the clock input from the clock unit 130. Then, the clock counter 113 outputs a count value A of the clock to the comparators 114a and 114b.

In the comparators 114a and 114b, one input terminal is connected to the clock counter 113 and the other input terminal is connected to the storing part 112. The comparator 114a compares the count value A input from the clock counter 113 with the value B of the number of clocks CPU_CLK supplied to the CPU 140 which is input from the storing part 112. The comparator 114a outputs the enable signal EN_BDM_CPU controlling on and off of the background debug mode for the CPU 140 to the clock supply control circuit 120. When A<B, the enable signal EN_BDM_CPU is 1 or High. On the other hand, when A≧B, the enable signal EN_BDM_CPU is 0 or Low. In summary, the enable signal EN_BDM_CPU=1 is output only within a range of predetermined number of clocks CPU_CLK.

The comparator 114b compares the count value A input from the clock counter 113 with the value C of the number of clocks PERI_CLK supplied to the peripheral device 162 such as the timer which is input from the storing part 112. Then, the comparator 114b outputs the enable signal. EN_BDM_PERI controlling on and off of the background debug mode for the peripheral device 162 such as the timer to the clock supply control circuit 120.

When A<C, the enable signal EN_BDM_PERI is 1 or High. On the other hand, when ARC, the enable signal EN_BDM_PERI is 0 or Low. In summary, the enable signal EN_BDM_PERI=1 is output only within a range of predetermined number of clocks PERI_CLK.

The clock supply control circuit 120 includes inverters 121a and 121b, NAND gates 122a and 122b, and AND gates 123a and 123b.

The input terminal of the inverter 121a is connected to the comparator 114a and the output terminal of the inverter 121a is connected to one input terminal of the NAND gate 122a. Then, the inverter 121a inverts the enable signal EN_BDM_CPU input from the comparator 114a to output the inverted signal to the NAND gate 122a.

Similarly, the input terminal of the inverter 121b is connected to the comparator 114b, and the output terminal is connected to one input terminal of the NAND gate 122b. Then, the inverter 121b inverts the enable signal EN_BDM_PERI input from the comparator 114b to output the inverted signal to the NAND gate 122b.

The STOP signal is input to the other input terminal of the NAND gate 122a. The STOP signal is the signal for stopping the clock and turning the mode to the low power consumption mode. The output terminal of the NAND gate 122a is connected to the clock unit 130 and one input terminal of the AND gate 123a.

Similarly, the STOP signal is input to the other input terminal of the NAND gate 122b. The output terminal of the NAND gate 122b is connected to the clock unit 130 and one input terminal of the AND gate 123b.

The other input terminal of the AND gate 123a is connected to the clock unit 130. The output terminal of the AND gate 123a is connected to the CPU 140, the memory 150, the flip flops 161a and 161b, and the IO port 163.

Similarly, the other input terminal of the AND gate 123b is connected to the clock unit 130. Then the output terminal of the AND gate 123b is connected to the peripheral device 162 such as the timer.

The clock unit 130 generates the clock and outputs the generated clock. When one of the signals output from the NAND gates 122a and 122b is 1, the clock unit 130 operates. On the other hand, when all the output signals of the NAND gates 122a and 122b are 0, the clock unit 130 stops.

The CPU 140 executes a program stored in the memory 150, and transmits/receives data to/from the peripheral unit 160.

The peripheral unit 160 includes the flip flops 161a and 161b, the peripheral device 162 such as the timer, and the IO port 163. As a matter of course, the components of the peripheral unit 160 are not limited to such examples. Further, although only two flip flops are shown in FIG. 1 for the sake of simplicity, more than two flip flops are generally arranged.

The thick lines in FIG. 1 show the data flow. The CPU 140 carries out data input/output in accordance with the clock between the memory 150 and the peripheral unit 160. The data output from the CPU 140 is temporarily stored in the flip flops 161a and 161b. Then, the data is input to the peripheral device 162 such as the timer as the clock is supplied to the peripheral device 162 such as the timer.

In the first exemplary embodiment, the clock output from the AND gate 123a or the clock supplied to the CPU 140 is also supplied to the flip flops 161a and 161b and the IO port 163 of the circuits in the peripheral unit 160. On the other hand, the clock output from the AND gate 123b is supplied to the peripheral device 162 such as the timer of the circuits in the peripheral unit 160. Accordingly, it is possible to carry out the background debug processing without operating the peripheral device 162 such as the timer, for example. In short, it is possible to reproduce the low power consumption mode in which the peripheral device 162 such as the timer does not operate.

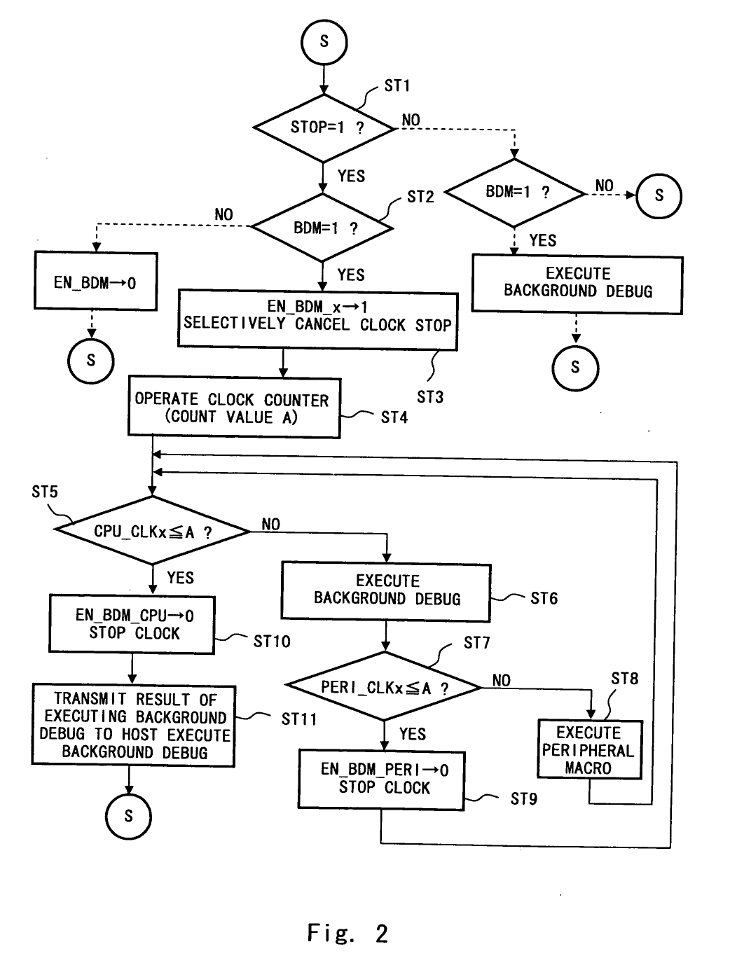

Now, the flow of the background debug processing in the low power consumption mode will be described with reference to the flowchart shown in FIG. 2.

First, the operation starts with the start state shown in S in FIG. 2, and it is determined whether the STOP signal shown in FIG. 1 is 1, which means STOP=1 (ST1). The STOP signal is input to the NAND gates 122a and 122b as shown in FIG. 1. When STOP=0 (ST1: NO), the mode is not the low power consumption mode but the normal operation mode. This case has no direct relation with the present invention. In this case, it is determined whether the background debug mode is ON, which means BDM=1 in FIG. 2. In case of YES, the state goes back to the start state after carrying out the background debug processing. On the other hand, in case of NO, the state goes back to the start state.

When STOP=1 or the low power consumption mode (ST1: YES), it is determined whether the background debug mode is ON, which means BDM=1 in FIG. 2 (ST2). When BDM=0 (ST2: NO), the background debug mode is OFF, which means the state in which the background debug processing is not to be executed. This case has no direct relation with the present invention. In this case, both of EN_BDM_CPU and EN_BDM_PERI in FIG. 1 are 0; and therefore, the state goes back to the start state while keeping the low power consumption mode (STOP=1).

On the other hand, when the command for the background debug is input from the host development system 170, BDM is 1 (ST2: YES). The following processing is the background debug processing in the low power consumption mode, which is the processing having direct relation with the present invention. CPU_CLK and PERI_CLK are selected from the command table 112a in accordance with the input command. As such, the enable signals EN_BDM_CPU and EN_BDM_PERI in FIG. 1 are 1. Then, the stop of the clock for the function block in which the enable signal EN_BDM_x is 1 is canceled, so as to start the background debug processing (ST3). Then, the clock counter 113 operates to output the count value A to the comparators 114a and 114b (ST4). The comparator 114a compares the value B which is the number of clocks CPU_CLKx supplied to the CPU 140 (x corresponds to 1, 2, 3 . . . ) which is selected from the command table 112a with the count value A (ST5).

The background debug processing is carried out (ST6) when A<B (ST5: NO). The circuit operation in this case is described with reference to FIG. 1. When the enable signal EN_BDM_CPU=1, the NAND gate 122a receives STOP=1, and 0 obtained by inverting the enable signal EN_BDM_CPU=1 by the inverter 121a. Accordingly, the NAND gate 122a outputs 1 (High), and this signal is input to one input terminal of the AND gate 123a. Then, the AND gate 123a outputs the clock in accordance with the clock from the clock unit 130 input to the other input terminal. This clock is supplied to the CPU 140, the memory 150, the flip flops 161a and 161b, and the IO port 163 in the example shown in FIG. 1.

On the other hand, the comparator 114b compares the value C of the number of clocks PERI_CLKx supplied to the peripheral device 162 such as the timer (x corresponds to 1, 2, 3 . . . ) selected from the command table 112a with the count value A (ST7).

The peripheral macro is executed, and the background debug processing for the peripheral device 162 such as the timer is executed (STB) when A<C (ST7: NO). Then, the process goes back to step ST5. The circuit operation in this case will be described with reference to FIG. 1. When the enable signal EN_BDM_PERI=1, the NAND gate 122b receives STOP=1, and 0 which is obtained by inverting the enable signal EN_BDM_PERI=1 by the inverter 121b. Accordingly, the NAND gate 122b outputs 1 (High), and this signal is input to one input terminal of the AND gate 123b. Then, the AND gate 123b outputs the clock in accordance with the clock from the clock unit 130 input to the other input terminal. This clock is supplied to the peripheral device 162 such as the timer in the example shown in FIG. 1.

When A≧C (ST7: YES), the enable signal EN_BDM_PERI is 0, and the clock supply to the peripheral device 162 such as the timer is stopped to terminate the background debug processing (ST9). Then, the process goes back to step ST5. The circuit operation in this case will be described with reference to FIG. 1. When the enable signal EN_BDM_PERI=0, the NAND gate 122b receives STOP=1, and 1 which is obtained by inverting the enable signal EN_BDM_PERI=0 by the inverter 121b. Accordingly, the NAND gate 122b outputs 0 (Low), and this signal is input to one input terminal of the AND gate 123b. Then, the AND gate 123b outputs 0 regardless of the clock from the clock unit 130 input to the other input terminal. As such, the clock stops.

When A≧B (ST5: YES), the enable signal EN_BDM CPU=0, and the clock supply to the CPU 140 stops to terminate the background debug processing (ST10). The circuit operation in this case will be described with reference to FIG. 1. When the enable signal EN_BDM_CPU=0, the NAND gate 122a receives STOP=1, and 1 which is obtained by inverting the enable signal EN_BDM_CPU=0 by the inverter 121a. Accordingly, the NAND gate 122a outputs 0 (Low), and this signal is input to one input terminal of the AND gate 123a. Then, the AND gate 123a outputs 0 regardless of the clock from the clock unit 130 input to the other input terminal. As such, the clock stops.

Lastly, the result of executing the background debug is transmitted to the host development system 170 (ST11). Then, the state goes back to the start state.

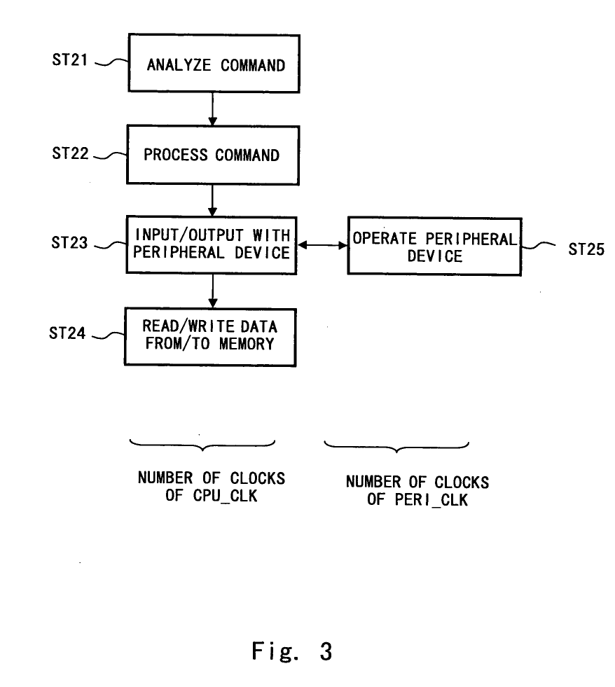

Next, a method of determining the number of clocks CPU_CLK and PERI_CLK stored in the command table 112a in FIG. 1 will be described with reference to the flowchart shown in FIG. 3. The method shown in FIG. 3 is merely an example as the processing is different for each command. The number of clocks CPU_CLK is determined by adding the number of clocks required for analyzing the command by the CPU 140 (ST21), the number of clocks required for carrying out the command processing by the CPU 140 (ST22), the number of clocks required for inputting/outputting data to/from the peripheral device (ST23), and the number of clocks required for reading/writing data from/to the memory 150 (ST24). On the other hand, PERI_CLK is only operated during a time at which the CPU 140 performs input/output operation with the peripheral device. As such, PERI_CLK can be determined from the number of clocks required for the operation of the peripheral device 162 such as the timer (ST25).

In the above-described exemplary embodiment, the example is shown in which the different number of clocks are supplied to the two function blocks. However, it is also possible to supply the different number of clocks to more than two function blocks. In such cases, the number of comparators 114, the number of inverters 121, the number of NAND gates 122, and the number of AND gates 123 may be increased in accordance with the number of clocks.

Further, the number of clock unit 130 is not limited to one, but the clock unit may be provided for each function block.

As explained in the above exemplary embodiment, in the data processing system according to the present invention, only the number of clocks needed for the background debug processing is supplied to the function block which is the background debug processing. Accordingly, it is possible to reproduce the low power consumption mode with higher accuracy. Furthermore, it is possible to carry out the background debug processing without operating the peripheral devices such as the timer, for example. As such, it is possible to reproduce the operation in the low power consumption mode in which the peripheral devices such as the timer do not operate with higher accuracy.

While the invention has been described in terms of several exemplary embodiments, those skilled in the art will recognize that the invention can be practiced with various modifications within the spirit and scope of the appended claims and the invention is not limited to the examples described above.

Further, the scope of the claims is not limited by the exemplary embodiments described above.

Furthermore, it is noted that, Applicant's intent is to encompass equivalents of all claim elements, even if amended later during prosecution.

What is claimed is:

1. A data processing system, comprising:
a function block that operates based on a clock;
a clock supply control circuit that controls supply of the clock based on an enable signal;
a storing part that stores a command table in which a debug command and a number of clocks needed to process the debug command by the function block are made correspondent to each other; and
a debug system part that executes debug processing based on an input debug command, wherein
the debug system part refers to the command table and outputs the enable signal in accordance with the number of clocks corresponding to the input debug command.

2. The data processing system according to claim 1, wherein
the debug system part further comprises:
a clock counter that counts the number of clocks supplied from the clock supply control circuit; and
a comparator that compares a value of the clock counter with the number of clocks, and
the debug system part outputs the enable signal in accordance with an output of the comparator.

3. The data processing system according to claim 1, wherein the debug system part further comprises a decoding part that decodes the input debug command, and the number of clocks is determined based on the decode result by the decoding part and the command table.

4. The data processing system according to claim 2, wherein the debug system part further comprises a decoding part that decodes the input debug command, and the number of clocks is determined based on the decode result by the decoding part and the command table.

5. The data processing system according to claim 1, wherein
the function block comprises a CPU and a peripheral function part,
the command table is the table in which the debug command and the numbers of clocks required for processing of the debug command by each of the CPU and the peripheral function part are made correspondent to each other,
the debug system part refers to the command table and outputs a CPU enable signal and a peripheral function part enable signal in accordance with the number of clocks corresponding to the input debug command, and
the clock supply control circuit controls clock supply to the CPU and to the peripheral function part in accordance with the CPU enable signal and the peripheral function part enable signal.

6. The data processing system according to claim 2, wherein
the function block comprises a CPU and a peripheral function part,
the command table is the table in which the debug command and the numbers of clocks required for processing of the debug command by each of the CPU and the peripheral function part are made correspondent to each other,
the debug system part refers to the command table and outputs a CPU enable signal and a peripheral function part enable signal in accordance with the number of clocks corresponding to the input debug command, and
the clock supply control circuit controls clock supply to the CPU and to the peripheral function part in accordance with the CPU enable signal and the peripheral function part enable signal.

7. A debug method of a device comprising a function block that operates based on a clock, the method comprising:
stopping a clock signal;
referring to a command table in which a debug command and a number of clocks needed to process the debug command by the function block are made correspondent to each other to supply the clock signal in accordance with the number of clocks corresponding to an input debug command; and
executing debug processing based on the input debug command.

8. The debug method according to claim 7, wherein
the function block comprises a CPU and a peripheral function part,
the command table is the table in which the debug command and the numbers of clocks required for processing of the debug command by each of the CPU and the peripheral function part are made correspondent to each other, and
the method comprises referring to the command table to supply the clock to each of the CPU and to the peripheral function part in accordance with the number of clocks corresponding to the input debug command.
